(19) United States
(12) Patent Application Publication
(10) Pub. No.: US 2026/0024997 A1
(43) Pub. Date: Jan. 22, 2026

(54) OPTIMISING THE USE OF RENEWABLE ENERGY

(71) Applicant: SAGEMCOM ENERGY & TELECOM SAS, BOIS-COLOMBES (FR)

(72) Inventors: Tareq ALNEJAILI, BOIS-COLOMBES (FR); Pierre SABATIER, BOIS-COLOMBES (FR)

(21) Appl. No.: 19/248,641

(22) Filed: Jun. 25, 2025

(30) Foreign Application Priority Data
Jun. 25, 2024 (FR) FR2406834

(51) Int. Cl. H02J 3/14; H02J 3/00; H02J 3/38

(52) U.S. Cl. CPC H02J 3/144; H02J 3/003; H02J 3/004; H02J 3/381; H02J 2203/20; H02J 2300/24; H02J 2310/14; H02J 2310/52; H02J 2310/60

(57) ABSTRACT

A method for optimising the consumption of an installation includes, carried out before a specified period, implementing a disaggregation method, so as to predict, for each appliance, an expected individual consumption profile, predicting an expected renewable production profile by the renewable energy source, defining first optimised individual consumption profiles for the appliances, making it possible to maximise a use of renewable electrical energy, and the second step of controlling the appliances during the specified period, by using the first optimised individual consumption profiles.

The invention relates to the field of electricity consumption management of an installation connected to a renewable energy source (photovoltaic panels, for example).

### BACKGROUND

Today, more and more domestic installations are connected to photovoltaic panels, which enables users to reduce both their electricity bills and their dependence on the traditional electricity network.

However, the periods of electricity consumption of the various appliances in an installation do not coincide with the solar energy production curve, leading to an underutilisation of the available solar energy. Thus, solar energy production is not optimised economically, technically and environmentally.

### AIM

The invention aims to optimise the consumption of renewable energy by the appliances and equipment of an installation connected to a renewable energy source.

### SUMMARY

In view of achieving this aim, a method for optimising an overall electricity consumption of an installation comprising appliances and connected to a renewable energy source is provided, the optimisation method comprising the first steps, carried out before a specified period, of:
acquiring measurements the of overall electricity consumption of the installation;
implementing a disaggregation method, so as to predict from said measurements, for each appliance, an expected individual consumption profile of said appliance as a function of the time during the specified period;
predicting an expected profile of renewable production by the renewable energy source as a function of the time during the specified period;
adapting the expected individual consumption profile of at least one appliance as a function of the expected renewable production profile, to define first optimised individual consumption profiles for the appliances, making it possible to maximise a use of a renewable electrical energy, produced by the renewable energy source, to power the appliances during the specified period;
   the optimisation method in addition comprising the second step, implemented during the specified period, of controlling the appliances by using the first optimised individual consumption profiles.

The implementation of the disaggregation method therefore makes it possible to predict, for the specified period (the following day, for example), the expected individual electricity consumption profiles of the different appliances in the installation. The individual profiles are thus adapted (by a time lag, for example) by taking into account the forecast for the specified period of renewable energy production, and the appliances are controlled by using the optimised individual profiles, which makes it possible to maximise the use of renewable energy.

The optimisation method therefore makes it possible to:
maximise self-consumption: the use of available renewable energy optimised to maximise self-consumption and minimise dependency on traditional energy sources;
achieve significant energy savings: thanks to a smart planning and optimisation of energy consumption, the user achieves significant energy savings on their electricity bills;
favour a more efficient and sustainable use of energy, which contributes to reducing greenhouse gas emissions and supports the transition to greener lifestyles;
provide a significant flexibility and adaptability: the optimisation method can be implemented in different domestic environments and energy configurations, thus offering a flexible solution for users.

In addition, an optimisation method is proposed, such as described above, in which the expected individual consumption profile of at least one appliance is also adapted, to obtain the first optimised individual consumption profile of said appliance, as a function of a user setpoint and/or an energy tariff.

In addition, an optimisation method such as described above is proposed, in which the prediction of the expected renewable production profile uses weather forecasts for the specified period.

In addition, an optimisation method such as described above is proposed, in which, for at least one appliance, the prediction of the expected individual consumption profile of said appliance uses weather forecasts for the specified period.

In addition, an optimisation method such as described above is proposed, comprising the steps, after implementing the disaggregation method, for:
classifying each appliance into at least one category from among a group of categories comprising at least three categories from among: interruptible appliance, non-interruptible appliance, appliance forming a mainly resistive load, appliance forming a mainly inductive load, appliance having a block-movable consumption;
defining the first optimised individual consumption profiles as a function of this classification.

In addition, an optimisation method such as described above is proposed, in which, for an interruptible appliance, the adaptation of the expected individual consumption profile comprises the steps of:
deactivating the interruptible appliance for at least one first period of low availability of renewable electrical energy;
reactivating the interruptible appliance for at least one first period of high availability of renewable electrical energy;
the first period of low availability and the first period of high availability belonging to the specified period.

In addition, an optimisation method such as described above is proposed, in which, for an appliance forming a mainly resistive load, the adaptation of the expected individual consumption profile comprises the steps of:
reducing a power consumed by said appliance during at least one second period of low availability of renewable electrical energy;
spreading the power consumed over an extended duration of time or increase the power consumed by said resistive appliance during at least one second period of high availability of renewable electrical energy; the second period of low availability and the second period of high availability belonging to the specified period.

In addition, an optimisation method such as described above is proposed, in which, for an appliance having a block-movable consumption, the adaptation of the expected individual consumption profile comprises the step of temporally moving a consumption of said appliance without changing a shape of said profile from a third period of low availability of renewable electrical energy to a third period of high availability of renewable electrical energy;
the third period of low availability and the third period of high availability belonging to the specified period.

In addition, an optimisation method such as described above is proposed, further comprising the second steps, during the specified period, of:
monitoring, in real time, a current production of the renewable energy source and/or a change in weather conditions and/or a current electricity consumption of at least one appliance;
adapting the first optimised individual consumption profiles as a function of the results of this monitoring, to produce second optimised individual consumption profiles for the appliances;
controlling the appliances by using the second optimised individual consumption profiles.

In addition, an optimisation method such as described above is proposed, comprising the step of implementing a fuzzy logic algorithm to define the first optimised individual consumption profile of at least one appliance.

In addition, an optimisation method such as described above is proposed, in which the fuzzy logic algorithm has, as inputs, several variables from among:
an irradiance predicted for the specified period;
a temperature predicted for the specified period;
at least one user setpoint;
at least one energy tariff.

In addition, an optimisation method such as described above is proposed, in which the fuzzy logic algorithm has an optimal start-up time for said appliance as its output.

In addition, an optimisation method such as described above is proposed, comprising the step of executing an inference of a previously trained machine learning model to define the first optimised individual consumption profile of at least one appliance.

In addition, an optimisation method such as described above is proposed, in which the machine learning model has, as inputs, several variables from among:
an irradiance predicted for the specified period;
a temperature predicted for the specified period;
at least one user setpoint;
at least one energy tariff.

In addition, an optimisation method such as described above is proposed, in which the machine learning model has an optimal start-up time for said appliance as its output.

In addition, a piece of management equipment is proposed, arranged to control the appliances in the installation, and comprising a processing unit in which at least some of the steps of the optimisation method such as described above are implemented.

In addition, a computer program is proposed, comprising instructions which make the processing unit of the management equipment such as described above execute the steps of the optimisation method such as described above.

Also proposed is a computer-readable storage medium on which the previously described computer program is stored.

The invention will be best understood, in the light of the description below of particular, non-limiting embodiments of the invention.

### BRIEF DESCRIPTION OF THE DRAWINGS

Reference will be made to the accompanying drawings, among which:

FIG. 1 shows an installation connected to a photovoltaic panel;

FIG. 2 shows steps of the optimisation method;

FIG. 3 shows graphs comprising a electricity consumption signature curves of different appliances;

FIG. 4 shows a graph comprising curves of the expected individual consumption profile of the water heater, and of the expected renewable production profile by the photovoltaic panels;

FIG. 5 shows a graph comprising curves of the first optimised individual consumption profile of the water heater, and the expected renewable production profile by the photovoltaic panels;

FIG. 6 shows a graph (on the left) comprising curves of the expected renewable production profile by the photovoltaic panels and of the expected individual consumption profiles of several appliances, and a graph (on the right) comprising curves of the expected renewable production profile by the photovoltaic panels and of the first optimised individual consumption profiles of these appliances;

FIG. 7 illustrates the implementation of the fuzzy logic algorithm.

### DETAILED DESCRIPTION

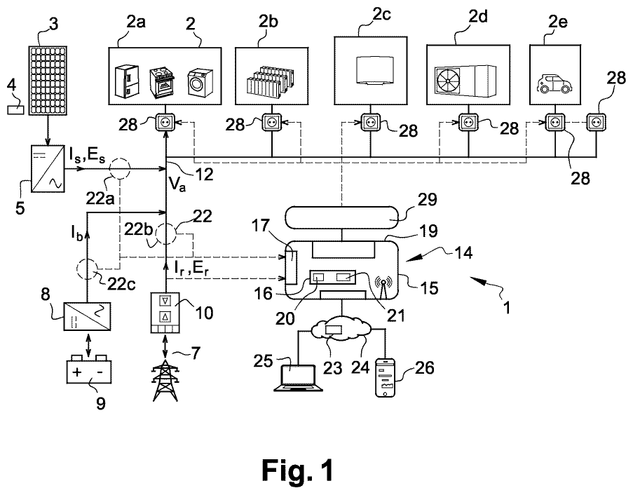

In reference to FIG. 1, a domestic installation 1, which, in this case, is integrated into the house of a user, comprises a certain number of appliances 2, the operation of which requires a power supply. These appliances 2, in this case, comprise household appliances 2a (refrigerator, oven, washing machine, etc.), electric heaters 2b (radiators, for example), a water heater 2c, an air-conditioning system 2d, and a charging station 2e for recharging the batteries of an electric car.

The installation 1 is connected to a renewable energy source, in this case, to photovoltaic panels 3 which are, for example, installed on the roof of the house (one single panel is shown in this case, but there can be one or more of them). The photovoltaic panels 3 are associated with irradiance sensors 4 which measure irradiance in real time. The photovoltaic panels 3 are connected to an inverter 5 which generates, from the (direct) current produced by the photovoltaic panels 3 under a solar (direct) voltage, a solar (alternating) current Is under a supply voltage Va (alternating), making it possible to power the appliances 2.

The installation 1 is also connected to the “traditional” electricity distribution network 7, which supplies it with network current Ir (alternating) under the supply voltage Va.

The installation 1 is also connected to a “hybrid” inverter 8, itself connected to batteries 9. The hybrid inverter 8 produces a (direct) current under a (direct) battery voltage, which can be stored in the batteries 9 when the electricity production of the photovoltaic panels 3 is greater than the need of the installation 1. Conversely, the hybrid inverter 8 can re-inject a battery current Ib (alternating) to power the installation 1 when this is necessary.

An electricity meter 10 is connected to the installation 1 and makes it possible to measure the network electrical energy Er supplied by the network 7 to the installation 1. The meter 10 is two-directional: it can also measure the solar electrical energy Es produced by the photovoltaic panels 3 and possibly re-injected into the network 7.

The inverter 5, the hybrid inverter 8 and the appliances 2 are all connected to the internal network 12 of the installation 1, to which the meter 10 is connected. The appliances 2 are therefore powered by two distinct sources: the network 7 which supplies the network electrical energy Er, and the photovoltaic panels 3 which supply the solar electrical energy Es (and the batteries 9 which store some of the solar electrical energy).

The installation 1, in addition, comprises a piece of management equipment 14, the role of which is to optimise the electricity consumption of the installation 1 to maximise the consumption of the solar electrical energy Es, which makes it possible to reduce the consumption by the installation 1 of the network electrical energy Er.

The management equipment 14 is installed in the house of the user, for example, in the proximity of the meter 10. The management equipment 14 comprises a housing 15 in which are integrated, a processing unit 16, analogue inputs 17, first communication means 18 and second communication means 19.

The processor module 16 is an electronic and software unit. The processor module 16 comprises at least one processing component 20, which is for example, a “general purpose” processor, a processor specialising in signal processing (or DSP, for Digital Signal Processor), a processor specialising in artificial intelligence algorithms (NPU-type, for Neural Processing Unit), a microcontroller, or a programmable logic circuit such as an FPGA (for Field Programmable Gate Arrays) or an ASIC (for Application Specific Integrated Circuit).

The processing unit 16 also comprises one or more memories 21, connected to or integrated in the one or more processing components 20. At least one of these memories 21 forms a computer-readable storage medium, on which at least one computer program is stored, comprising instructions which cause the processing unit 16 to perform at least some of the steps of the optimisation method that will be described.

The analogue inputs 17 of the management equipment 14 are connected to sensors 22, among which are found: a current sensor 22a which measures the solar current Is, a current sensor 22b which measures the network current Ir, a current sensor 22c which measures the battery current Ib, and a voltage sensor (not shown), which measures the alternating voltage Va.

The analogue inputs 17 of the management equipment 14 are also connected to the irradiance sensors 4 of the photovoltaic panels 3.

All the sensors 4, 22 are “pre-existing” sensors, conventionally present in an installation such as the installation the management equipment 14 is therefore connected, to implement the invention.

The first communication means 18 enable the management equipment 14 to communicate with one or more remote servers 23 of the cloud 24 (optionally via a gateway integrated into the installation 1). The first communication means 18 also enable the user to communicate with the management equipment 14, for example via an application loaded on their smartphone 25, or via their computer 26 (and optionally via the cloud 24).

In particular, the management equipment 14 can acquire weather forecasts to anticipate solar production conditions and the future electricity consumption needs of the appliances 2. For example, weather forecasts can comprise outside temperature forecasts and irradiance forecasts.

The second communication means 19 enable the management equipment 14 to implement communication to control the appliances 2 of the installation 1. In this case, by “controlling”, this means producing any control which impacts on the power consumption of the appliance. For example, this control is an activation of the appliance 2, a deactivation, an adjustment of any output level of the appliance (temperature, for example), etc.

The second communication means 19 can also enable the management equipment 14 to communicate with the meter 10.

The first communication means 18 and the second communication means 19 comprise wired and/or wireless and/or power line carrier means, which implement one or more known communication protocols, and for example, NB-IoT, LTE-M, 2G, 3G, 4G, 5G, CPL, Wi-Fi, etc.

In this case, each appliance 2 of the installation 1 is connected to a remote module 28. All the remote modules 28 are connected, in this case, to a centralised module 29.

In this case, the remote modules 28 are connected electrical sockets. In this case, the centralised module 29 is a “smart” domestic module which controls the appliances 2 via the remote modules 28.

The control of the appliances 2 performed by the management equipment 14 via the centralised module 29 and the remote modules 28. The management equipment 14 uses its second communication means 19 to transmit the controls to the centralised module 29, which retransmits them (after processing/shaping, if necessary) to the remote modules 28.

It must be noted, that several appliances 2 can be connected to one same remote module 28 and controlled via said remote module 28. One or more appliance groups 2 can be formed. The management equipment 14 thus possibly sends one same setpoint to the entire group of appliances 24.

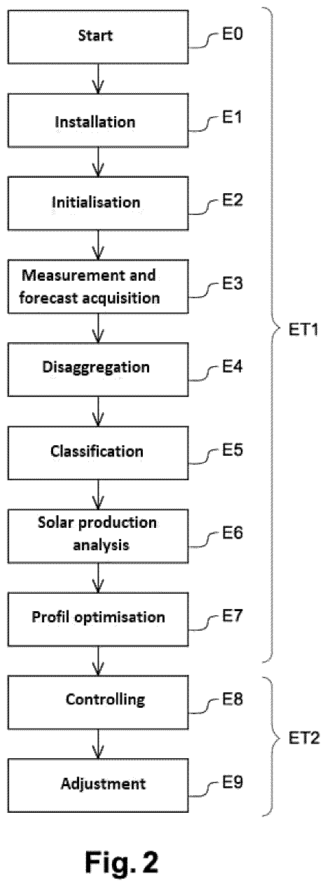

The implementation of the optimisation method by the management equipment 14 will now be focused on, in reference to FIG. 2.

The optimisation method comprises first steps ET1 and second steps ET2.

The first steps ET1 are implemented before a specified period. In this case, for each current day D (i.e. for each “present” day), the specified period is the day following D+1, i.e. the day following the current day.

The second steps ET2 are implemented during the specified period, i.e. the following day, i.e. the day following the current day.

First, the first steps ETI will be focused on.

The optimisation method starts at step E0.

The management equipment 14 is installed by the user or by a technician in the installation 1, and is connected to the appliances 2, to the sensors 4, 22, to the meter 10 optionally, and to the server(s) 23 of the cloud 24: step E1. These couplings can be completely automatic, without any intervention of the user.

The management equipment 14 is therefore simply added to the installation 1. It is connected to pre-existing equipment and does not require any particular additional equipment. The implementation of the optimisation method is therefore extremely simple and flexible, since it only requires the management equipment 14 to be installed.

The processor unit 16 implements an initialisation step E2. The processing unit 16 configures the connections to the appliances 2, to the different sensors 4, 22, to the servers 23 and to the meter 10 (if necessary).

Steps E0 to E2 are carried out one single time. However, if the configuration of the installation 1 changes (new appliances, new sensors, etc.), the initialisation step E2 can be repeated.

Each day, the processing unit 16 loads the weather forecasts, and in particular, the temperature and irradiance forecasts for the following day. The processing unit 16 can thus anticipate the solar electricity production and the consumption needs of the following day (D+1).

The processing unit 16 recovers the measurements of the overall electricity consumption of the installation 1 and the measurements of the solar electricity production by the photovoltaic panels 3: step E3.

These measurements are available via the sensors 4, 22 and optionally by interrogating the meter 10.

By “overall electricity consumption”, this means the consumption of the entire installation 1, without distinguishing between the appliances 2.

Step E3 is performed continuously, every day.

The processing unit 16 therefore continuously acquires the forecasts and the measurements of the overall weather electricity consumption of the installation 1.

The processing unit 16 thus implements a disaggregation method, so as to predict from said measurements, for each appliance 2, an expected individual electricity consumption profile of said appliance 2 as a function of time during the specified period (therefore, for the following day): step E4. Each expected individual profile is, for example, formed from power consumption values as a function of time, during the specified period.

The disaggregation makes it possible to detect the different consumers in the house. The disaggregation of the total electricity consumption of the house, in real time, makes it possible to identify and monitor the consumption of each electrical appliance 2 or group of appliances.

The disaggregation process is repeated regularly to detect new appliances.

The non-intrusive disaggregation identifies the consumption of each appliance 2 by detecting in the measurements of the overall electricity consumption, an electrical signature associated with said appliance 2 (i.e. a particular shape of a consumption curve as a function of time). For this, the processing unit 16 analyses, for example, the intensity and voltage curves, with a frequency, for example, of around 10 kHz, and which, in this case, is between 5 kHz and 20 KHz.

The disaggregation method is repeated regularly to detect new appliances.

The disaggregation method is known to a person skilled in the art.

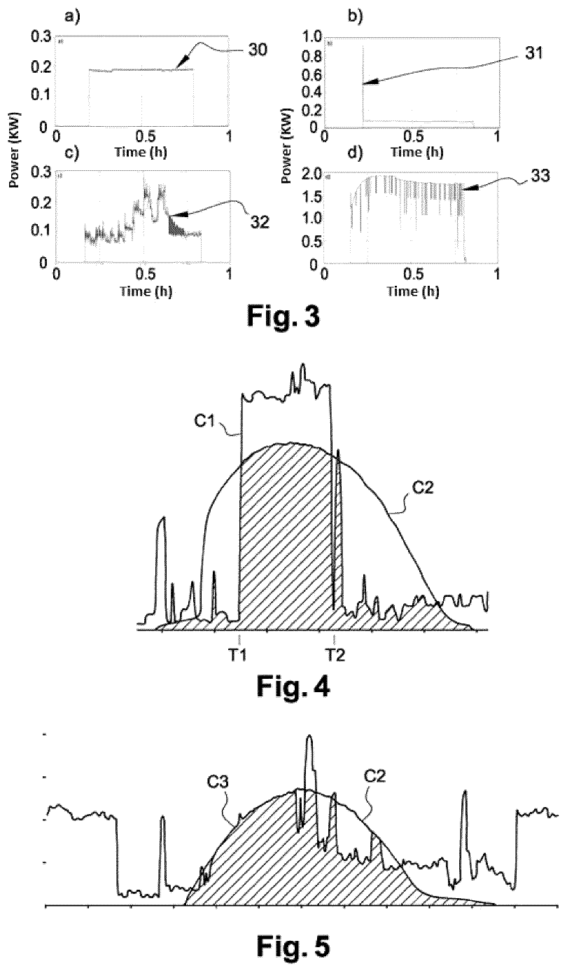

FIG. 3 shows signatures for four types of appliances:
signature 30 of an appliance in a state without significant peak; this is a lamp, for example;
signature 31 of an appliance in a state with significant peak; this is a refrigerator, for example;
signature 32 of a non-linear appliance; this is a laptop, for example;
signature 33 of a continuous appliance with decrease; this is an air-conditioning unit, for example.

These data come from the document [Pascal Schirmer, Iosif Mporas, Akbar Sheikh Akbari. ‘Robust energy disaggregation using appliance-specific temporal contextual information’ EURASIP Journal on Advances in Signal Processing. [2020].

The processing unit 16 therefore obtains, after a time of observation of the consumption of the house, for example, a few weeks, a list of appliances which consume in the house.

The disaggregation can also identify the consumption profile for a group of appliances using a signature making it possible to identify said group.

The processing unit 16 records the data of each appliance 2 or group of appliances.

Following the disaggregation step, the processing unit 16 classifies each appliance 2 or group of appliances into at least one of the categories of a group of categories: step E5. The group of categories comprises at least three of the following categories:
interruptible appliance;
uninterruptible appliance;
appliance forming a mainly resistive load;
appliance forming a mainly inductive load;
appliance having a block-movable consumption.

Interruptible appliances can be switched on or off “as desired”. For example, they are interruptible to the nearest second. On the contrary, uninterruptible appliances, once they have started up, can no longer be deactivated.

For example, appliances forming a mainly resistive load comprise a purely resistive water heater, a radiator, etc.

For example, appliances forming a mainly inductive load comprise appliances integrating a motor.

Appliances having a block-movable consumption have an electricity consumption, the profile of which can be moved temporally, while keeping its initial shape.

Uninterruptible appliances having non-movable consumption comprise, for example, the refrigerator, the freezer, the lighting system, etc.

For example, uninterruptible appliances having a block-movable consumption comprise a thermodynamic water heater integrating a heat pump. Such a hot water tank is not interruptible, simply unless it damages the heat pump.

Then, the processing unit 16 analyses the measurements of the solar electricity production and predicts an expected renewable production profile by the at least one photovoltaic panel 3 as a function of time during the following day: step E6.

The processing unit 16, for this, monitors and analyses the renewable (solar) production in real time, and records the solar energy production data to calculate the available energy.

Again, the expected renewable production profile is, for example, formed from power values produced as a function of time, during the specified period.

The processing unit 16 will thus adapt the expected individual electricity consumption profile of at least one appliance 2 from the expected renewable production profile, to define first optimised individual consumption profiles for the appliances 2, making it possible to maximise a use of solar electrical energy to power the appliances 2 during the specified period: step E7.

The expected individual consumption profile of at least one appliance 2 is also adapted, to obtain the first optimised individual consumption profile of said appliance, as a function of a user setpoint and/or an energy tariff.

If, for an appliance 2, the expected individual profile is not adapted, as it has already been optimised, it is considered that the first optimised individual profile is the expected individual profile for said appliance 2.

The processing unit 16 simulates a start-up of the appliances 2. The processing unit 16 therefore virtually compares the consumption data of the appliances 2 with the solar energy production forecasts, and simulates the operation of the different appliances as a function of the solar consumption and energy production forecasts. The processing unit 16 thus determines the appropriate times to start up or switch off certain appliances, but also, when this is possible, adapts the powers consumed, in order to optimise the use of solar energy. The simulation will determine the appropriate times to use the solar energy produced, in order to maximise self-consumption. The processing unit 16 consequently adapts the load of the electrical appliances 2 (for example, offsetting the operating periods, reducing the power of certain appliances, increasing the power during a certain period and reducing it during another period, sequencing the consumption in different disjoint periods, etc.).

The processing unit 16 defines the first optimised individual consumption profiles as a function of the result of the classification of the appliances.

The adaptation of the individual consumption profiles of the appliances 2 will therefore depend on the category (or categories) in which the appliance 2 has been classified.

For example, for an interruptible appliance, the adaptation of the expected individual consumption profile comprises the steps of:
deactivating the interruptible appliance during at least one first period of low availability of renewable electrical energy (in this case, solar);
reactivating the interruptible appliance during at least one first period of high availability of renewable electrical energy (in this case, solar);
   the first period of low availability and the first period of high availability belonging to the specified period (in this case, the following day).

The periods of low availability of solar energy can correspond to periods during which the panels 3 produce little, but also, to periods during which the overall consumption of the installation is high.

For an appliance forming a mainly resistive load, the adaptation of the expected individual consumption profile comprises the steps of:
reducing a power consumed by said appliance during at least one second period of low availability of renewable electrical energy;
spreading the power consumed over an extended duration of time or increasing the power consumed by said resistive appliance for at least one second period of high availability of renewable electrical energy;
   the second period of low availability and the second period of high availability belonging to the specified period.

For an appliance having a block-movable consumption, adapting the expected individual consumption profile comprises the step of temporally moving a consumption of said appliance without changing the shape of the profile from a third period of low availability of renewable electrical energy to a third period of high availability of renewable electrical energy; the third period of low availability and the third period of high availability belonging to the specified period (in this case, the following day).

Steps E6 and E7 are, in this case, carried out each current day, to predict and optimise the profiles for the following day. These steps are therefore repeated daily.

The second steps ET2 will now be focused on, implemented during the specified period, i.e. during the following day D+1.

The processing unit 16 controls the appliances 2 by using the first optimised individual consumption profiles: step E8.

The processing unit 16, in this case, uses the centralised module 29 and the remote modules 28 to adjust the operation of the appliances 2 as a function of the results of the optimisation. The processing unit 16 allocates the load between the appliances so as to maximise energy efficiency.

In addition, during the specified period, the processing unit 16:
monitors, in real time, a current production of photovoltaic panels 3 and/or a change in weather conditions (temperature, irradiance, etc.) and/or a current electricity consumption of at least one appliance 2;
adapts the first optimised individual consumption profiles as a function of the results of this monitoring, to produce second optimised individual consumption profiles for the appliances;
controls the appliances by using the second optimised individual consumption profiles.

The processing unit 16 therefore adjusts the parameters of the profile optimisation algorithm as a function of the results obtained to improve efficiency and energy savings: step E9.

In particular, the processing unit 16 monitors, in real time, a current production of the photovoltaic panels 3. The processor unit 16 adapts the first optimised individual consumption profiles as a function of the current production to produce second optimised consumption profiles for the appliances 2.

The processing unit 16 can also detect the electricity consumption of new appliances. By continuing to monitor the energy consumption of the house, the processing unit 16 detects the possible addition of new electrical appliances. The processing unit 16 can thus propose a new test period to evaluate the impact of these appliances on overall energy consumption.

Again, if for an appliance 2, the associated first optimised individual profile is not adapted as already optimised, it is considered that the second optimised profile is the first optimised profile for said appliance.

The result of implementing the optimisation method on a purely resistive water heater is now described.

FIG. 4 shows the expected individual consumption profile (curve C1) of the water heater 2c as a function of time during the following day, as well as the expected renewable production profile (curve C2) by the photovoltaic panels 3, such as predicted by the processing unit 16. The water heater 2c is, in this case, controlled with an “on/off” control. The power consumed is particularly high between times T1 and T2 and exceeds, in this time interval, the available solar electrical power. The remaining power must be supplied by the network 7, and therefore, at a high tariff.

During the current day, the processing unit 16 adapts the expected individual consumption profile of the water heater and defines a first optimised individual consumption profile. In reference to FIG. 5, on the following day, the processing unit 16 controls the water heater 2c by using the first optimised individual consumption profile (curve C3). The processing unit 16, for this, controls the water heater 2c by using a power variation control. The processor unit 16 will thus reduce the power consumed by the water heater during the period of low availability of solar electrical energy, and spread the power consumed over an extended period.

Thus, even if the operating time of the water heater is longer, almost all the power supplied to the water heater comes from the photovoltaic panels 3. The optional complement, highly reduced, is supplied by the network 7.

The use of the first optimised individual consumption profile for the water heater therefore makes it possible to maximise the use of solar electrical energy.

Concerning electric radiators, their overall consumption is analysed and control will be considered optionally via a “control wire”-type control.

Electric vehicle charging can also be 100% solar, like on the curves.

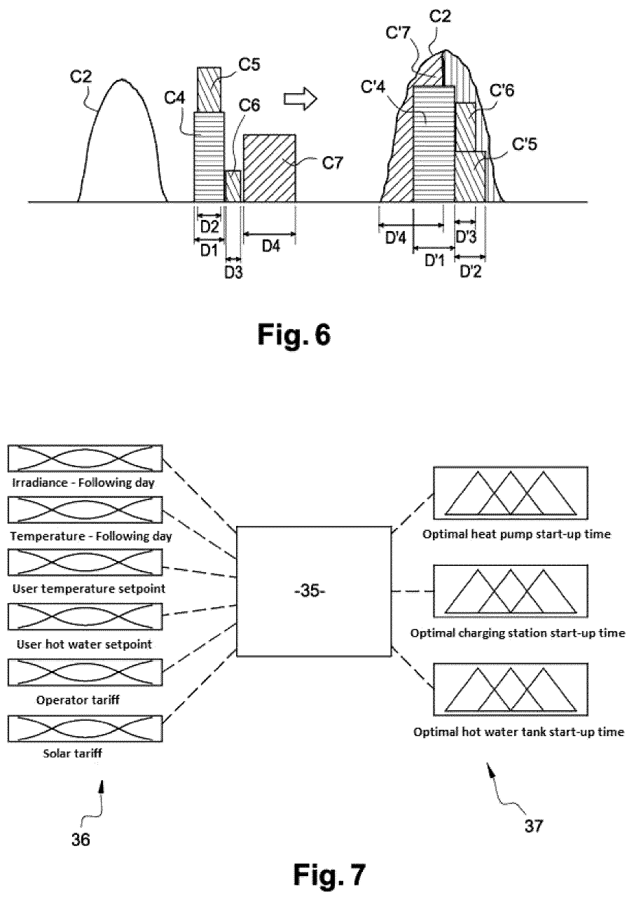

The graph on the left of FIG. 6 shows the expected individual consumption profiles, predicted, during the current day, by the processing unit 16 for the following day and for four appliances: the heating system heat pump (curve C4), which consumes electrical energy mainly during the period D1, the water heater (curve C5), which consumes electrical energy mainly during the period D2, any machine (curve C6), which consumes electrical energy mainly during the period D3, and the charging station (curve C7), which consumes electrical energy mainly during the period D4.

The curve C2 corresponds to the expected renewable production profile for the specified period (the following day).

It can be seen that according to the predictions made, and without optimisation of the consumption profiles, solar electrical energy will be poorly utilised, as the appliances consume mainly during periods D1, D2, D3, D4 of low availability of solar electrical energy.

On the graph on the right, it is seen that the first optimised individual consumption profiles, which have been defined by the processing unit 16 during the current day and which are used to control the appliances 2 during the following day: curve C′4 for the heat pump of the heating system, curve C′5 for the water heater, curve C′6 for the machine, curve C′7 for the charging station.

It is seen that:
the consumption of the heat pump, of the water heater and of the machine, which, in this case, are appliances having a block-movable consumption, are moved respectively from the periods D1, D2, D3 (of high availability of solar electrical energy) to the periods D′1, D′2, D′3 (of high availability of solar electrical energy);
the consumption of the charging station is offset from the period D4 (of high availability of solar electrical energy) to the period D′4 (of high availability of solar electrical energy). The shape of the profile is modified.

The use of solar energy has thus been optimised to power these appliances.

In an embodiment, the processing unit 16 implements a fuzzy logic algorithm to define the first optimised individual consumption profile of at least one appliance 2.

This approach, based on fuzzy logic, can take into account various variables such as, for example, weather forecasts (for example, predicted irradiance for the following day, predicted outside temperature for the following day), customer setpoints for temperature and hot water, operator and solar tariffs, etc.

The output of the algorithm is, for example, the optimal start-up time of an appliance, for example, the charging station, the water heater or the heat pump.

To achieve this aim, the algorithm analyses, in real time, weather data, irradiance sensor data 4, customer preferences, then makes smart decisions about switching appliances 2 on or off. For example, if the predicted irradiance for the following day is high and the solar tariff is low, the algorithm can decide to start up the charging station in the afternoon to maximise the use of solar energy. Likewise, if the outside temperature is low and the hot water setpoint of the customer is high, the water heater can be programmed to start up in the morning to supply hot water for the shower.

Thus, in reference to FIG. 7, the fuzzy logic algorithm 35 has, as inputs 36, several variables from among:
an irradiance predicted for the specified period;
a temperature predicted for the specified period;
at least one user setpoint;
at least one energy tariff.

The inputs 26 therefore comprise, in this case, for example, all or some of the following variables:
Irradiance of the following day; temperature of the following day: each of these inputs can be divided into several categories (members of the fuzzy set) such as “low”, “medium” and “high”, depending on the predicted irradiance and temperature value;
User temperature setpoint; user hot water setpoint: the temperature and hot water reference desired by the user can be classified into categories such as “low”, “normal”, and “high”;
Operator tariff; solar tariff: each of these inputs shows energy tariffs, classified as “low”, “medium”, and “high” as a function of their value.

The fuzzy logic algorithm 35 has, for example, as output 37, for each appliance 2, an optimal start-up time for said appliance 2. This output corresponds to the optimal time to start up the appliance. It can be classified into categories such as “morning”, “noon”, and “evening”.

The processing unit 16 can adapt the inputs 36 and the outputs 37 of this algorithm 35 as a function of the specific appliances detected by the disaggregation of the load. For example, if additional appliances are detected, their states can be included as additional inputs in the algorithm. Likewise, the outputs of the algorithm can be modified to include the control of these additional appliances, in addition to the heat pump, the water heater and the charging station.

The processing unit 16 can integrate new inputs and outputs. Other parameters can also be included as inputs in the algorithm. For example, the battery charge level of the electric vehicle can be monitored and used as an entry to plan charging more efficiently. Likewise, other equipment such as domestic energy storage systems or energy management devices can be integrated into the system for a more holistic management of energy consumption.

A first example of implementing the fuzzy logic algorithm 35 is now described.

The membership functions and fuzzy rules are described for a fuzzy logic algorithm 35 which uses the data inputs (irradiance of the following day, temperature of the following day, customer temperature setpoint, customer hot water setpoint, operator tariff, solar tariff) to determine the optimal start-up time for controlling the appliances as a function of the disaggregation.

In this example, the membership functions are as follows:
Irradiance-following day:
   Low: Triangular from 0 to 300 W/m²;
   Medium: Triangular from 200 to 800 W/m²;
   High: Triangular from 600 to 1200 W/m²;
Temperature-following day:
   Low: Triangular from 0 to 15° C.;
   Normal: Triangular from 10 to 25° C.;
   High: Triangular from 20 to 35° C.
Customer temperature setpoint:
   Low: Triangular from 18 to 22° C.;
   Normal: Triangular from 20 to 24° C.;
   High: Triangular from 22 to 26° C.
Customer hot water setpoint:
   Low: Triangular from 40 to 50° C.;
   Normal: Triangular from 50 to 60° C.;
   High: Triangular from 60 to 70° C.
Operator tariff:
   Low: Triangular from €0 to €0. 15/kWh;
   Medium: Triangular from €0.10 to €0.30/kWh;
   High: Triangular from €0.25 to €0.50/kWh.
Solar tariff:
   Low: Triangular from €0 to €0. 05/kWh;
   Medium: Triangular from €0.04 to €0.10/kWh;
   High: Triangular from €0.08 to €0. 15/kWh.
Optimal starting time:
   Morning: Triangular from 6:00 AM to 11:00 AM;
   Noon: Triangular from 11:00 AM to 02:00 PM;
   Afternoon: Triangular from 02:00 PM to 06:00 PM;
   Evening: Triangular from 06:00 PM to 08:00 PM;
   Night: Triangular from 08:00 PM to 06:00 AM.
Controlling the charging station, hot water tank and heat pump:
   Switched off: Triangular from 0 to 0.5;
   On: Triangular from 0.5 to 1.

For example, the fuzzy rules are as follows for controlling the heat pump:
If the customer temperature setpoint is “high” and the irradiance of the following day is “high”, then:
   If the inside temperature is “low”, then the heat pump must be “on” in the morning to heat the house before sunrise;
   Otherwise, if the inside temperature is “normal”, then the heat pump must be “on” in the afternoon to maintain a comfortable temperature.
If the customer temperature setpoint is “normal” and the irradiance of the following day is “medium”, then:
   If the inside temperature is “low”, then the heat pump must be “on” in the afternoon to maintain a comfortable temperature;
   Otherwise, if the inside temperature is “normal”, then the heat pump must remain “off” to save energy.

For example, the fuzzy rules are as follows for controlling the hot water tank:
If the customer hot water setpoint is “high” and the irradiance of the following day is “high”, then:
   If the outside temperature is “low”, then the hot water tank must be “on” in the morning to supply hot water for the shower;
   Otherwise, if the outside temperature is “normal”, then the hot water tank must be “on” at the end of the morning to meet the predicted demand for hot water;
   Otherwise, if the outside temperature is “high”, then the hot water tank must be “on” in the afternoon to meet the demand for hot water for cooking and washing.
If the customer hot water setpoint is “normal” and the irradiance of the following day is “medium”, then:
   If the outside temperature is “low”, then the hot water tank must be “on” at the end of the morning to provide hot water for the shower;
   Otherwise, if the outside temperature is “normal”, then the hot water tank must be “on” in the afternoon to meet the predicted demand for hot water.

An example of the result of the algorithm is given for controlling the hot water tank:

If [irradiance, hot water setpoint, outside temperature]=[700 W/m², 44° C., 15° C.], then the optimal time to start up the hot water tank is 7:00 AM.

For example, the fuzzy rules are as follows for controlling the charging station:
If the customer temperature setpoint is “low” and the operator tariff is “low” and the irradiance predicted for the following day is “high” and the solar tariff is “low”, switch on the charging station in the afternoon to maximise the use of solar energy. (priority with respect to cost-effectiveness);
If the irradiance predicted for the following day is “medium” and the operator tariff is “low”, then: Switch on the charging station in the morning to recharge the battery at a lower cost;
If the irradiance predicted for the following day is “medium” and the solar tariff is “high”, then: Switch on the charging station in the afternoon to maximise the use of solar energy.

Described below is a second example.

The inputs are as follows:
Irradiance (D+1): Very Low, Low, Medium, High, Very High;
Temperature (D+1): Very cold, Cold, Comfortable, Warm, Very hot;
Customer temperature setpoint: Very Low, Low, Medium, High, Very High;
Customer hot water setpoint: Very Low, Low, Medium, High, Very High;
Operator tariff: Very Low, Low, Medium, High, Very High;
Solar tariff: Very Low, Low, Medium, High, Very High;
Time of day: Night, Early Morning, Morning, Noon, Afternoon, Evening, Night.

The outputs are the following:
Optimal starting time: Night, Early Morning, Morning, Noon, Afternoon, Evening;
Control controls (On/Off): Charging station, Water heater, Heat pump.

In this example, the membership functions are as follows:
Irradiance:
   Very low: 0≤Irradiance≤100 W/m²;
   Low: 101≤Irradiance≤300 W/m²;
   Medium: 301≤Irradiance≤600 W/m²;
   High: 601≤Irradiance≤900 W/m²;
   Very high: Irradiance>900 W/m².
Temperature:
   Very cold: Temperature≤12° C.;
   Cold: 16° C.;
   Comfortable: 22° C.;
   Hot: 26° C.;
   Very hot: 26° C.;
Customer temperature setpoint:
   Very low: 12≤Temperature setpoint≤15° C.;
   Low: 16 ≤Temperature setpoint≤19° C.;
   Medium: 20≤Temperature setpoint≤23° C.;
   High: 24≤Temperature setpoint≤27° C.;
   Very high: Temperature setpoint>27° C.
Customer hot water setpoint:
   Very low: 0≤Hot water setpoint≤20%;
   Low: 21≤Hot water setpoint≤40%;
   Medium: 41 ≤Hot water setpoint≤60%;
   High: 61≤Hot water setpoint≤80%;
   Very high: Hot water setpoint>80%.
Operator tariff:
   Very low: 0≤Tariff≤€0.05/kWh;
   Low: 0.06≤Tariff≤€0.10/kwh;
   Medium: 0.11≤Tariff≤€0.15/kWh;
   High: 0.16≤Tariff≤€0.20/kwh;
   Very high: Price>€0.20/kWh.
Solar tariff:
   Very low: 0≤Tariff≤€0.05/kWh;
   Low: 0.06≤Tariff≤€0.10/kWh;
   Medium: 0.11≤Tariff≤€0.15/kwh;
   High: 0.16≤Tariff≤€0.20/kWh;
   Very high: Price>€0.20/kWh.
Time of day:
   Night: 00:00 AM≤Time≤06:00 AM;
   Early morning: 06:01 AM≤Time≤07:30 AM;
   Morning: 07:31 AM≤Time≤09:00 AM;
   Noon: 09:01 AM≤Time≤02:00 PM;
   Afternoon: 02:01 PM≤Time≤06:00 PM;
   Evening: 06:01 PM≤Time≤08:00 PM;
   Night: 08:01 PM≤Time≤00:00 AM.

For example, the fuzzy rules are as follows for controlling the heat pump:
If the irradiance is very low and the temperature is very cold and the customer temperature setpoint is High or Very High, then the optimal start-up time of the heater is in the early morning to maintain the heat;
If the irradiance is low and the temperature is cold, and the customer temperature setpoint is High or Very High, then the optimal heating start-up time is in the morning to use solar energy and guarantee comfort;
If the irradiance is medium and the temperature is cold, and the customer temperature setpoint is High or Very High, then the heating can start up in the morning or at noon to balance the solar energy with comfort;
If the irradiance is high and the temperature is cold, and the customer temperature setpoint is High or Very High or Medium, then the heating must start up at noon to maximise the use of solar energy;
If the irradiance is very high and the temperature is cold, and the customer temperature setpoint is High or Very High or Medium, then the heating can start up at noon or in the afternoon to manage solar overproduction;
If the irradiance is very low and the temperature is comfortable, and the customer temperature setpoint is High or Very High or Medium, then the heating must start up in the early morning to maintain the heat;
If the irradiance is low and the temperature is comfortable, and if the customer temperature setpoint is Low or Very Low or Medium, then the heating must start up in the morning to use solar energy;
If the irradiance is medium and the temperature is comfortable, and the customer temperature setpoint is High or Very High or Medium, then the heating can start up in the morning or at noon to balance the solar energy with comfort;
If the irradiance is high and the temperature is comfortable, and the customer temperature setpoint is Low or Very Low, then heating is not necessary to save energy;
If the irradiance is very high and the temperature is comfortable, and the customer temperature setpoint is Low or Very Low, then heating is not necessary and air-conditioning can be activated for comfort.

It must be noted, that these rules can be further refined as a function of the specificities of the system and of the needs of users.

For example, the fuzzy rules are as follows for controlling the water heater:
If the hot water setpoint is very low and the irradiance is very low, then the optimal start-up time is defined as “Night”;
If the hot water setpoint is very low and the irradiance is low, then the water heater can be activated for a short time to use solar energy. The optimal starting time is defined as “Early Morning”;
If the hot water setpoint is very low and the irradiance is medium, then the water heater can be activated for a longer time to maximise the use of solar energy. The optimal start-up time is defined as “Morning”;
If the hot water setpoint is very low and the irradiance is high, then the water heater can be activated most of the day to benefit from solar energy. The optimal start-up time is defined as “Morning” or “Noon”;
If the hot water setpoint is very low and the irradiance is very high, then the water heater can be activated all day to maximise the use of solar energy. The optimal start-up time is set as “Morning” or “Noon” or “Afternoon”;
If the hot water setpoint is low and the irradiance is very low, the optimal start-up time is defined as “Night”;
If the hot water setpoint is low and the irradiance is low, then the water heater can be activated for a short time to use solar energy. The optimal start-up time is defined as “Early Morning”;
If the hot water setpoint is low and the irradiance is medium, then the water heater can be activated for a moderate duration to balance the solar energy with the hot water need. The optimal start-up time is defined as “Morning” or “Noon”;
If the hot water setpoint is low and the irradiance is high, then the water heater can be activated for a large part of the day to maximise the use of solar energy. The optimal start-up time is defined as “Morning” or “Noon” or “Afternoon”;
If the hot water setpoint is low and the irradiance is very high, then the water heater can be activated taking into account the solar tariff to avoid overproduction. The optimal start-up time is defined as “Morning” or “Noon” or “Afternoon”.

For example, the fuzzy rules are as follows for controlling the charging station:
If the irradiance is very high and the solar tariff is very low, then the start-up time of the charging station is in the early morning (maximum priority to solar energy);
If the irradiance is high and the solar tariff is very low or low, then the start-up time of the charging station is in the early morning or morning (priority to solar energy);
If the irradiance is medium and the solar tariff is very low or low, then the start-up time of the charging station is in the morning or noon (balance between solar energy and vehicle charging);
If the irradiance is low and the solar tariff is very low, then the starting time of the charging station is noon or afternoon (priority to solar energy while limiting the discharge of the network);
If the irradiance is very low or the solar tariff is high, the charging station must not be activated (priority to energy saving).

It must be noted, that these rules assume that the electric vehicle is connected to the charging station. The system can also integrate information about the charge level of the vehicle to refine activation decisions.

In another embodiment, to define the first optimised individual consumption profiles for the appliances 2, the processing unit 16 (or a server 23 of the cloud 24, controlled by the processing unit 16) executes at least one inference of at least one machine learning model.

Again, the optimisation takes into account several variables such as the irradiance predicted for the following day, the outside temperature predicted for the following day, the customer setpoint, for example, for the temperature and hot water, as well as the operator and solar tariffs. The main aim of this optimisation is to determine the optimal start-up time of the appliances, and for example, the charging station, the hot water tank and the heat pump, as a function of the predicted weather conditions and customer preferences.

For example, the model can be an artificial neural network (ANN) or a reinforcement learning (RL) algorithm. In this case, we use an artificial neural network.

The processing unit 16 firstly collects data for a certain time.

The data collected comprise “historical” data, and for example, data on solar irradiance, outside temperature, energy tariffs, domestic energy consumption, etc.

The data collected also comprise data obtained in real time, via measurements taken by the sensors.

The processing unit 16 enables the data collected to be pre-processed. The processing unit 16 cleans and standardises the data collected to make it compatible with the model used.

The data collected is divided into a training dataset and a test dataset.

The model is designed as follows:

A model is designed with entry layers corresponding to the entry parameters used (for example, irradiance, temperature, customer setpoints, energy tariffs).

Hidden layers are used to capture complex non-linear relationships between the variables.

An output layer is added to predict optimal appliance start-up times.

The model is then driven in the processing unit 16 or, preferably, on a server (for example, the cloud 24), by using backpropagation and optimisation techniques to minimise the prediction error.

To assess its performance, the model is then validated against the test dataset.

Each current day, the processing unit 16 executes an inference of the previously trained model to make real-time predictions and define the optimised profiles as a function of the weather data and customer preferences.

The start-up times of the appliances are consequently adjusted.

The use of a machine learning model has the following advantages:
increased accuracy: machine learning models, in particular based on neural networks, can capture complex relationships between variables, which can lead to more accurate predictions.
adaptability: machine learning models, in particular based on neural networks, can be adapted to new data and changes in environmental conditions or customer preferences.
continuous optimisation: machine learning models, in particular based on neural networks, can be continuously updated and improved as new data are collected.

During the execution of the inference of the model, performed by the processing unit 16 (or by a server), the inputs applied as entry of the model are, for example:
an irradiance predicted for the specified period (in this case, for the following day);
a temperature predicted for the specified period (in this case, for the following day);
at least one user setpoint (temperature and hot water);
at least one energy tariff (for example, operator and solar).

The output of the model is, for example, the optimal start-up time of the equipment (charging station, water heater, heat pump).

By using this approach, the algorithm aims to optimise the use of available energy, to reduce dependence on traditional energy sources and to achieve significant energy savings for users. In addition, by taking into account weather forecasts and customer preferences, the algorithm can smartly plan the operation of electrical equipment, thus contributing to a more efficient use of energy resources.

Naturally, the invention is not limited to the embodiments described, but comprises any variant entering into the scope of the invention such as defined by the claims.

It is described, in this case, that the management equipment 14 controls the electrical appliances 2 via a centralised module 29 and remote modules 28. These modules are optional. The management equipment could control one or more appliances without using a centralised module, and even directly, without using a centralised module or a remote module.

First means of communication and second means of communication of the management equipment have been distinguished from one another, in this case. These first and second communication means can be grouped together entirely or partially into one single module.

The specified period is not necessarily the following day, this can also be a different “future” period, for example the next week, the next two days, etc.

All the steps of the optimisation method are not necessarily carried out in the processing unit; some could be carried out in another equipment, and for example, in one or more cloud servers. For example, the fuzzy logic algorithm can be executed on the cloud. Likewise, as has been seen if a machine learning model is used, it can be trained on the cloud. The execution of inferences of the trained model can also be performed on the cloud.

The renewable energy source does not necessarily comprise a photovoltaic panel. This could be another energy source, for example, a wind turbine.

The management equipment can be installed anywhere in the installation. It can be integrated in an equipment performing other functions (meter, for example). One same piece of management equipment could connected be to several installations.

The expected individual consumption profiles and the optimised individual profiles can be defined for groups of appliances (for example, several radiators).

1. An optimisation method for optimising an overall electricity consumption of an installation comprising appliances and connected to a renewable energy source, the optimisation method comprising the first steps, carried out before a specified period, of:
acquiring measurements of the overall electricity consumption of the installation;
implementing a disaggregation method so as to predict from said measurements, for each appliance, an predicted individual consumption profile of said appliance as a function of time during the specified period;
predicting an expected renewable production profile by the renewable energy source as a function of time during the specified period;
adapting the predicted individual consumption profile of at least one appliance as a function of the expected renewable production profile, to define first optimised individual consumption profiles for the appliances, making it possible to maximise a use of renewable electrical energy, produced by the renewable energy source, to power the appliances during the specified period;
the optimisation method in addition comprising the second step, implemented during the specified period, of controlling the appliances using the first optimised individual consumption profiles.

2. The optimisation method according to claim 1, wherein the expected individual consumption profile of at least one appliance is also adapted, to obtain the first optimised individual consumption profile of said appliance, as a function of a user setpoint and/or of an energy tariff.

3. The optimisation method according to claim 1, wherein the prediction of the expected renewable production profile uses weather forecasts for the specified period.

4. The optimisation method according to claim 1, wherein, for at least one appliance, the prediction of the expected individual consumption profile of said appliance uses weather forecasts for the specified period.

5. The optimisation method according to claim 1, further comprising the steps, following the implementation of the disaggregation method, of:
classifying each appliance into at least one category from among a group of categories comprising at least three categories from among: interruptible appliance, uninterruptible appliance, appliance forming a mainly resistive load, appliance forming a mainly inductive load, appliance having a block-movable consumption;
defining the first optimised individual consumption profiles as a function of this classification.

6. The optimisation method according to claim 5, wherein, for an interruptible appliance, the adaptation of the expected individual consumption profile comprises the steps of:
deactivating the interruptible appliance during at least one first period of low availability of renewable electrical energy;
reactivating the interruptible appliance during at least one first period of high availability of renewable electrical energy;
the first period of low availability and the first period of high availability belonging to the specified period.

7. The optimisation method according to claim 5, wherein, for an appliance forming a mainly resistive load, the adaptation of the expected individual consumption profile comprises the steps of:
reducing a power consumed by said appliance during at least one second period of low availability of renewable electrical energy;
spreading the power consumed over an extended duration or increase the power consumed by said resistive appliance during at least one second period of high availability of renewable electrical energy;
the second period of low availability and the second period of high availability belonging to the specified period.

8. The optimisation method according to claim 5, wherein, for an appliance having a block-movable consumption, the adaptation of the expected individual consumption profile comprises the step of temporally moving a consumption of said appliance without changing a shape of said profile from a third period of low availability of renewable electrical energy to a third period of high availability of renewable electrical energy;
the third period of low availability and the third period of high availability belonging to the specified period.

9. The optimisation method according to claim 1, further comprising the two steps, during the specified period, of:
monitoring, in real time, a current production of the renewable energy source and/or a change in weather conditions and/or a current electricity consumption of at least one appliance;
adapting the first optimised individual consumption profiles as a function of the results of this monitoring, to produce second optimised individual consumption profiles for the appliances;
controlling the appliances by using the second optimised individual consumption profiles.

10. The optimisation method according to claim 1, including the step of implementing a fuzzy logic algorithm to define the first optimised individual consumption profile of at least one appliance.

11. The optimisation method according to claim 10, wherein the fuzzy logic algorithm has, as inputs, several variables from among:
an irradiance predicted for the specified period;
a temperature predicted for the specified period;
at least one user setpoint;
at least one energy tariff.

12. The optimisation method according to claim 10, wherein the fuzzy logic algorithm has as output, an optimal start-up time for said appliance.

13. The optimisation method according to claim 1, comprising the step of executing an inference of a previously trained machine learning model to define the first optimised individual consumption profile of at least one appliance.

14. The optimisation method according to claim 13, wherein the machine learning model has, as inputs, several variables from among:
an irradiance predicted for the specified period;
a temperature predicted for the specified period;
at least one user setpoint;
at least one energy tariff.

15. The optimisation method according to claim 13, wherein the machine learning model has, as output, an optimal start-up time for said appliance.

16. A management equipment, arranged to control the appliances of the installation, and comprising a processing unit in which are implemented, at least some of the steps of the optimisation method according to claim 1.

17. (canceled)

18. A non-transitory computer-readable storage medium on which a computer program is stored, wherein the computer program comprises instructions which make a processing unit of management equipment execute the steps of the optimisation method according to claim 1.
